(19) United States
(12) Patent Application Publication
(10) Pub. No.: US 2007/0062926 A1
(43) Pub. Date: Mar. 22, 2007

(54) Electric heat-reserving box

(76) Inventor: Ming-Tsung Lee, Tainan City (TW)

Correspondence Address: Ming-Tsung LEE, P.O. BOX 90, Tainan City, 70499, TW

(21) Appl. No.: 11/228,277

(22) Filed: Sep. 19, 2005

(51) Int. Cl. A21B 1/00

(52) U.S. Cl. 219/400

(57) ABSTRACT

An electric heat-reserving box includes a receiving frame, a separating plate, an electric heater, a heat-insulating plate, a bottom plate and plural food trays. The receiving frame has a hollow interior with an upper holding rim. The separating plate positioned under the receiving frame is provided with a switch and a rotary button, having its opposite sides respectively fixed with a handle. The electric heater is assembled in the separating plate and connected with the switch and the rotary button, controlled by the switch to be turned on or off. The heat-insulating plate and the bottom plate are assembled under the electric heater, and the food trays are placed on the receiving frame. The switch is turned on to let the electric heater produce heat source supplied to the food trays, and the rotary button functions to regulate the temperature.

### BACKGROUND OF THE INVENTION

1. Field of the Invention

This invention relates to an electric heat-reserving box, particularly to one composed of a receiving frame, a separating plate, an electric heater, a heat-insulating plate, a bottom plate and plural food trays. The receiving frame is formed with a hollow interior having its upper peripheral edge provided with a holding rim. The separating plate positioned under the receiving frame is provided with a switch and a rotary button and has its opposite sides respectively fixed with a handle. The electric heater is installed in the separating plate and connected with both the switch and the rotary button, controlled by the switch to be turned on or off. The heat-insulating plate and the bottom plate are orderly assembled under the electric heater, and plural food trays are to be placed on the receiving frame. In using and operating, simply turn on the switch to let the electric heater produce heat source for supplying the food trays with heat energy, and then turn the rotary button to regulate the temperature after food is into the food trays, convenient in regulating and maintaining the temperature and safe in operating and using.

2. Description of the Prior Art

A conventional way to keep food hot is to place a food tray on a container filled therein with hot water to let the hot vapor of the hot water in the container heat the food in the food tray. However, after a period of time, the hot water in the container will naturally cooled down, and it is necessary to change or add hot water to the container, resulting in much trouble in using. Although an alcohol burner positioned under the hot water container can be used for keeping hot the water in the container for a comparatively long time, yet a user has to watch the remaining amount of an alcohol ointment (or alcohol cake) any time and be careful to add alcohol ointment. In addition, a user must be careful not to touch the alcohol burner when he replaces the food trays and not to let fuel leak outward when he adds alcohol ointment, otherwise accidents are likely to occur.

### SUMMARY OF THE INVENTION

The objective of the invention is to offer an electric heat-reserving box able to regulate and maintain the temperature, and safe in operating and using.

The electric heat-reserving box in the present invention includes a receiving frame formed with a hollow interior having its upper peripheral edge provided with a holding rim. A separating plate positioned under the receiving frame is provided with a switch and a rotary button and has its opposite sides respectively fixed with a handle. An electric heater is installed in the separating plate and connected with both the switch and the rotary button as well as with an electric wire, controlled by the switch to be turned on or off. A heat-insulating plate and a bottom plate are orderly assembled under the electric heater, and plural food trays are to be placed on the receiving frame.

### BRIEF DESCRIPTION OF DRAWINGS

This invention will be better understood by referring to the accompanying drawings, wherein:

FIG. 1 is an exploded perspective view of an electric heat-reserving box in the present invention;

FIG. 2 is a perspective view of the electric heat-reserving box in the present invention;

FIG. 3 is a cross-sectional view of the electric heat-reserving box in the present invention; and

FIG. 4 is a perspective view of the electric heat-reserving box in a using condition in the present invention.

### DETAILED DESCRIPTION OF THE PREFERRED EMBODIMENT

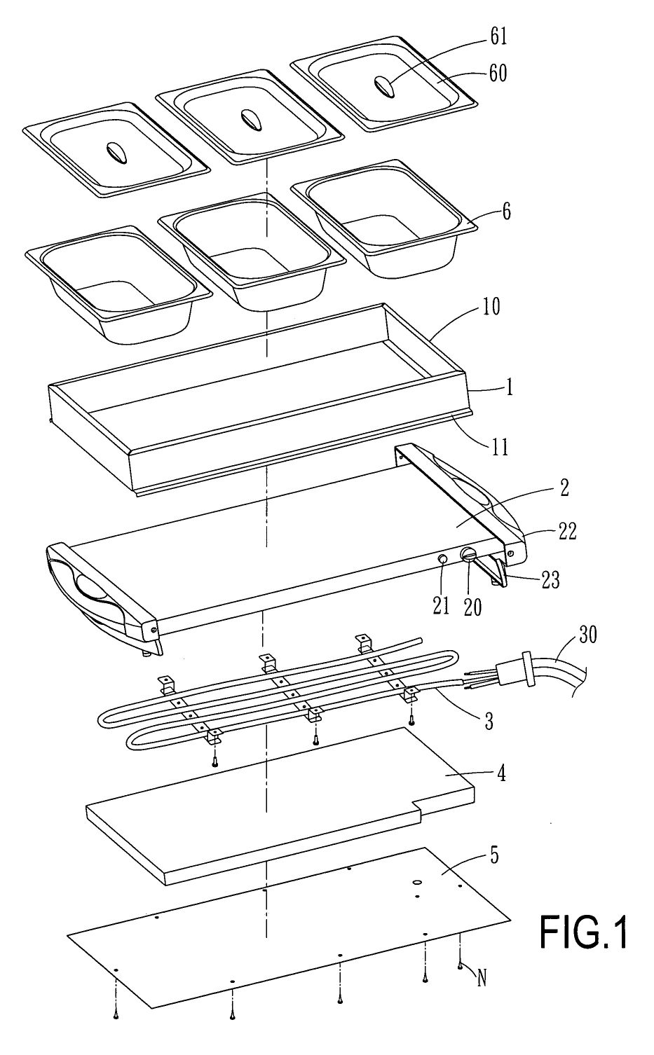

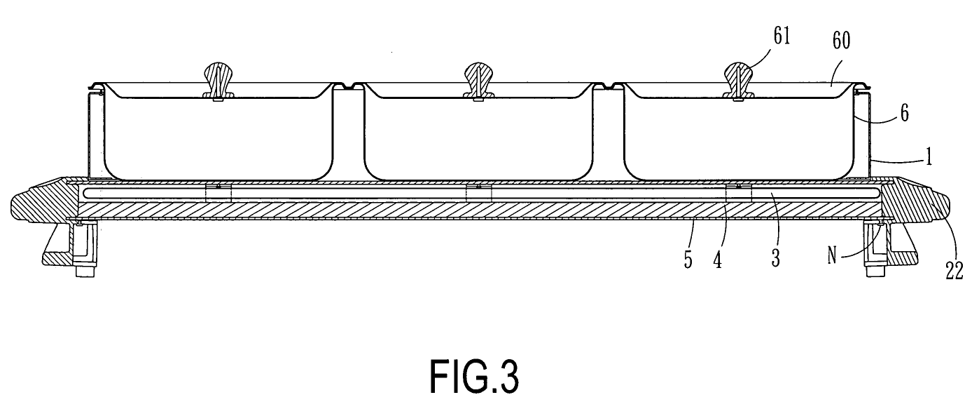

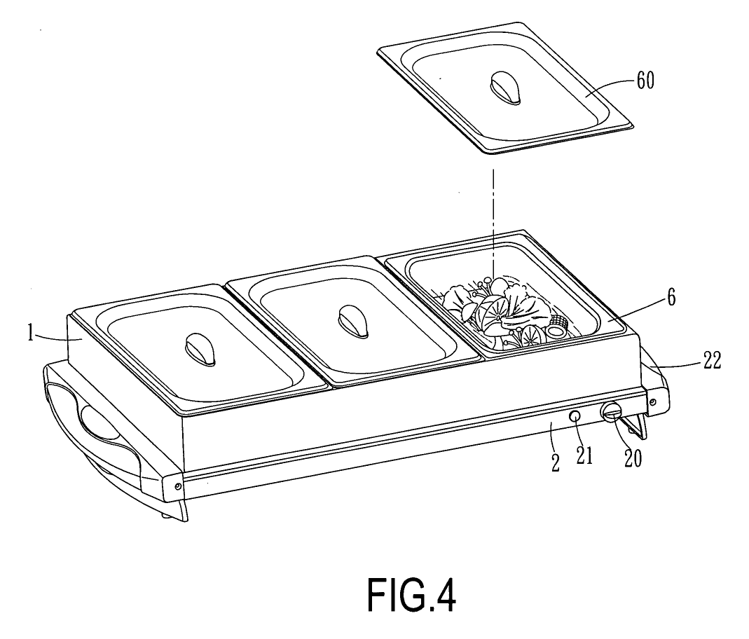

A preferred embodiment of an electric heat-reserving box in the present invention, as shown in FIGS. 1 to 4, includes a receiving frame 1, a separating plate 2, an electric heater 3, a heat-insulating plate 4, a bottom plate 5 and plural food trays 6 combined together.

The receiving frame 1 is formed with a hollow interior having its upper peripheral edge provided with a holding rim 10 and has its underside disposed with a combining edge 11 at two lengthwise sides.

The separating plate 2 positioned under the receiving frame 1 is provided with a switch 20 and a rotary button 21 and has its lateral opposite sides respectively fixed with a handle 22, and two support frames 23 respectively positioned under the handle 23.

The electric heater 3 is installed in the separating plate 2 and connected with both the switch 20 and the rotary button 21 as well as with electric wires 30, controlled by the switch 20 to be turned on or off.

The heat-insulating plate 4 and the bottom plate 5 are orderly assembled under the electric heater 3 by means of bolts N.

The food trays 6 to be placed on the receiving frame 1 are respectively provided thereon with a cover 60 having a knob 61 fixed on the topside.

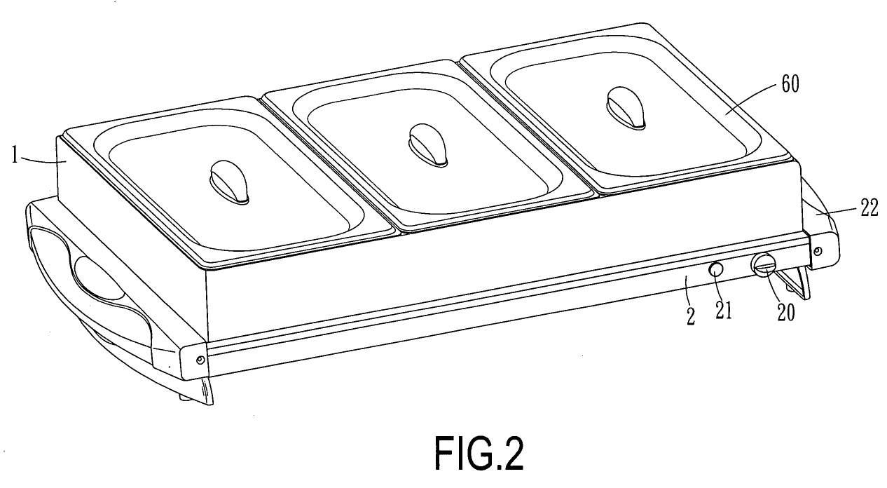

In assembling, as shown in FIGS. 2, 3 and 4, firstly, the electric heater 3 is installed in the separating plate 2 and the electric wires 30 are respectively connected with the switch 20 and the rotary button 21. Next, the heat-insulating plate 4 and the bottom plate 5 are threadably assembled under the electric heater 3, and the receiving frame 1 is mounted on the separating plate 2 by having its combining edges 11 firmly held on the separating plate 2. Lastly, the food trays 6 are placed on the receiving frame 1 and supported in position by the holding rim 10 of the receiving frame 1.

In using, as shown in FIGS. 2, 3 and 4, the switch 20 is turned on to let the electric heater 3 produce heat source for supplying the food trays 6 with heat energy, and the rotary button 21 is turned to regulate the temperature. Then, food is placed in the food trays 6, and the covers 60 are respectively covered on the food trays 6, convenient in regulating and maintaining the temperature and safe in handling.

As can be understood from the above description, this invention has the following advantages.

1. It is convenient in using and safe in operating.

2. The electric heater 3 is electrically connected to produce heat source for supplying the food trays with heat energy, and the rotary button can be turned for controlling and regulating the temperature.

While the preferred embodiment of the invention has been described above, it will be recognized and understood that various modifications may be made therein and the appended claims are intended to cover all such modifications that may fall within the spirit and scope of the invention.

What is claimed is:

1. An electric heat-reserving box comprising:
a receiving frame formed with a hollow interior having its upper peripheral edge provided with a holding rim;
a separating plate positioned under said receiving frame, said separating plate provided with a switch and a revolving button, said separating plate having its lengthwise opposite sides respectively fixed with a handle;
an electric heater installed in said separating plate, said electric heater connected with both said switch and said rotary button, said electric heater controlled by said switch to be turned on or off, said electric heater further connected with electric wires;
a heat-insulating plate and a bottom plate assembled under said electric heater;
plural food trays placed on said receiving frame; and
said switch turned on to let said electric heater produce heat source for supplying said food trays with heat energy, said rotary button turned to regulate the temperature after food is placed in said food trays on said receiving frame, convenient in regulating and maintaining the temperature and safe in operating.

2. The electric heat-reserving box as claimed in claim 1, wherein said receiving frame has its underside provided with a combining edge at two lateral opposite sides.

3. The electric heat-reserving box as claimed in claim 1, wherein said separating plate has its lateral opposite sides respectively fixed with a support frame under said handle.

4. The electric heat-reserving box as claimed in claim 1, wherein each said food tray is provided thereon with a cover having a knob fixed on the topside.
